(19) United States
(12) Patent Application Publication
(10) Pub. No.: US 2017/0361982 A1
(43) Pub. Date: Dec. 21, 2017

(54) A Storage and Display Device and System

(71) Applicant: K. Hartwall Oy Ab, Söderkulla (FI)

(72) Inventor: Joseph Patrick Kelly, Blackrock (IE)

(73) Assignee: K. Hartwall Oy Ab, Söderkulla (FI)

(21) Appl. No.: 15/535,388

(22) PCT Filed: Dec. 10, 2015
(86) PCT No.: PCT/EP2015/079301

§ 371 Date: Jun. 12, 2017

(30) Foreign Application Priority Data
Dec. 10, 2014 (IE) S2014/0309

(51) Int. Cl. B65D 21/02; B65D 6/26; B65D 6/00; B65D 6/18; B60P 3/025

(52) U.S. Cl. CPC B65D 21/0213; B65D 11/20; B65D 11/1833; B65D 7/42; B65D 7/30; B65D 7/26; B60P 3/0255

(57) ABSTRACT

The present invention relates to storage and display device comprising a base wall and a side wall that are connected together and operable to move between a folded and an expanded configuration, the expanded configuration defining an interior region for the storage of product between the side wall and the base wall, and the side wall and the base wall are arranged to provide a top opening and a side opening to the interior region. The device comprises at least one locking arm arrangement comprising a pair of connected locking arms each having a side wall engaging locking surface and together operable to move between a locked configuration and an unlocked configuration in the expanded configuration of the device. The locking arm arrangement strengthens and provides considerable stability and rigidity to the device in the expanded configuration by preventing sideways movement or wobble of the side wall when of the device in the expanded configuration. The present invention provides a re-usable storage and display device for the transport and display of product, such as in a retail environment.

### BACKGROUND

The present invention relates to a storage and display device, and to a system comprising a plurality of connected storage and display devices.

Devices or containers used for storing and transporting articles and products suffer from the drawback that they are suitable to be used only once, and as such, are non-returnable for re-use and so are discarded by the end user.

Another issue with such known non-returnable storage devices is that the products stored must be removed and stacked on separate display units so that customers at a retail outlet may view and select products.

In some retail outlets it is known practice for retail staff to tear away or otherwise remove a side wall of a storage container to form an opening so that the products contained within a container may be displayed and accessed via the opening by customers. In this arrangement, the storage device thus functions as a storage device for transporting the products and also as a display unit for the products within the outlet. Other non-returnable containers are rigid complex constructions with restricted frontal access due to the need to have structural support that will maintain the integrity of the stacked unit but in doing so partly restrict access at the front of the stacked merchandising unit, which is undesirable for brand owners.

However, such containers having a torn away side opening section are also usually stacked to provide a multi-layered display arrangement in a retail outlet for the products. Such an arrangement is often structurally unstable since the containers are not inherently designed to be used in this manner, and the removal of a side wall to facilitate the display of the products further reduces the structural integrity of the container and the display arrangement.

It is a therefore an object of the present invention to provide a storage and display device, and a system comprising a plurality of connected storage and display devices which goes at least some way toward overcoming the above problems and/or which will provide the public and/or industry with a useful alternative.

Further aspects of the present invention will become apparent form the ensuing description which is given by way of example only.

### SUMMARY

As disclosed in the present application, there is provided a storage and display device comprising:
a base wall and a side wall,
the base wall and the side wall are operable to move between a folded configuration and an expanded configuration,
in which in the expanded configuration an interior region for the storage of product is defined between the side wall and the base wall, and the side wall and the base wall are arranged to provide a top opening and a side opening to the interior region;
characterised in that the device comprises at least one locking arm arrangement comprising a pair of connected locking arms each having a side wall engaging locking surface and together operable to move between a locked configuration and an unlocked configuration in the expanded configuration of the device, in which in the locked configuration the side wall engaging locking surface of each locking arm abuts against a surface of the side wall, and in the unlocked configuration the side wall engaging locking surface of the locking arm is disengaged from the surface of the side wall of the device.

The present disclosure describes a re-usable storage and display device comprising of a base wall and a side wall that connect together so that the device may be moved from a folded stored configuration to an expanded configuration having an interior space for the storage and display of product. The device comprises a locking arm arrangement comprising a pair of connected locking arms which are together moved to a locked configuration in which they are operable to engage against the side wall of the device in the expanded configuration. The locking arm arrangement strengthens and provides considerable stability and rigidity to the device in the expanded configuration by preventing sideways movement or wobble of the side wall when of the device in the expanded configuration. The device is further used for the transport of articles. The locking arrangement of the device described in the present disclosure will remove the need for and compensate for traditional stabilising structures at the side or top opening, such as dedicated frames. The device disclosed by the present disclosure facilitates open shelf access to product stored in the interior region of the device with minimal obstructions at the openings.

In another embodiment, each locking arm arrangement further comprises an elongate locking bar, and the locking arms are connected at respective ends of the locking bar, whereby movement of the locking bar moves the locking arms between the locked configuration and the unlocked configuration. The locking bar is operable to be lifted to pull the locking arms into engagement with the side wall to stabilise the device in the expanded configuration. The locking bar is operable to apply a force against the locking arms to push the locking arms into a firm engagement with the side wall. The locking bar engages the locking arms above the level of the pivotal connection mechanism between the side wall and the base wall. This arrangement delivers maximum stabilising force without the need for a dedicated frame adjacent the side or top opening, which is of particular utility in a stacked configuration of the device.

For example, in each locking arm arrangement, a first end of each locking arm is connected to the locking bar and a second end is pivotably connected to the base wall and/or the side wall. The provision of such a locking bar configuration further stabilises and adds strength to prevent sideways wobble of the side wall.

For example, a locking arm arrangement is provided substantially adjacent to the side opening of the device, whereby in the locked configuration the locking bar is operable to apply a force against each locking arm to push the side wall engaging locking surface of each locking arm into firm engagement against an interior surface of the side wall.

For example, in the locked configuration of the locking arm arrangement provided at the side opening of the device the locking bar extends fully across the side opening between the locking arms.

For example, a locking arm arrangement is provided substantially adjacent to the top opening of the device, whereby in the locked configuration the locking bar is operable to apply a force against each locking arm to push the side wall engaging locking surface of each locking arm into firm engagement against an interior surface or an exterior surface of the side wall.

For example in the locked configuration of the locking arm arrangement provided at the top opening of the device the locking bar extends fully across the top opening between the locking arms.

In another embodiment, a channel is provided in the base wall for storage of the locking arm arrangement provided adjacent to the side opening, wherein the locking bar is moveable from the channel to move the locking arm arrangement to the locked configuration.

For example, a locking bar guide in the form of a groove is provided on the interior surface of the side wall.

For example, the locking bar guide is provided as a track that extends along the side wall in the direction of movement of the locking bar adjacent to the side opening.

For example, the locking extensions project from respective first ends of the locking arm into the track, the locking extensions operable to move within the track when the locking bar is moved between the locked and unlocked configurations.

For example, the device further comprises a front wall ledge which extends at least partially adjacent the side opening, the front wall ledge comprising locking arm receivers for the locking arms in the locked configuration. Such a front wall ledge operates to further prevent sideways movement of the locking arms in the locked configuration of the locking arrangement which transfers further stability to the side wall.

For example, an arrangement of side wall stacking projections are provided along a top edge of the side wall and extend proud of the top opening, and a plurality of stacking projection receivers are provided on an underside of the base wall.

In another embodiment, one or more side wall stacking projections are provided adjacent to the side opening of the device.

In another embodiment, the stacking projection receivers are provided at spaced apart intervals at the perimeter of the underside of the base wall.

In another embodiment, the stacking projection receivers are shaped to provide a tongue and groove or complimentary fit with the side wall projections.

In another embodiment, the stacking projections are provided at spaced apart intervals along the top edge of the side wall of the device.

In another embodiment, the stacking projection receivers are operable to slidingly and releasably engage with the stacking projections of a further device to provide a stacked configuration comprising at least two devices.

For example, at least one locking rib is provided on one or both of: the stacking projections and the stacking projection receivers.

For example, the locking rib is provided on an inner surface of the stacking projection receiver and is operable to engage with a stacking projection to secure the stacked devices together.

For example, a locking rib is provided on a surface of a stacking projection and is operable to engage with a stacking projection receiver to secure the stacked devices together. This prevents devices accidentally disconnecting during handling and transportation.

For example, the side wall and base wall are connected by a tongue and groove arrangement, whereby a projecting tongue along one of the side wall and a perimeter of the base wall is operable to slidingly fit into a groove that extends along the other of the side wall and a perimeter of the base wall.

For example, the device is re-useable.

In another embodiment, the device is injection molded and made of a polymer.

For example, the device is made of one or combinations of: polycarbonate, polypropylene, and polyethylene.

For example, the device comprises regions reinforced with cardboard and/or a medium density fibreboard and/or metal.

For example, the side wall and/or base wall is made of one of, or combinations of: a polymer material; a composite material; a metal material and a fibreboard material.

In another embodiment, the side wall comprises a pair of opposing side panels and a back panel, in which the side panels are spaced apart on the base wall by the back panel to define the interior region in the expended configuration.

For example, the side panels and the back panel extend upright on the base wall when in the expanded configuration. The side panels may be of different or be of the same height as the back panel.

Alternatively, the side wall may comprises only of a pair of opposing side panels, and not include a back panel, to facilitate front and read access to the device in the expanded configuration.

In another embodiment, the side and back panels are pivotably connected to the base wall by connection means.

In another embodiment, the connection means comprises a hinge and a hinge pin.

In another embodiment, the base wall comprises a rim at a perimeter thereof, the rim forming a receiving guide for positioning the side panels and/or the back panel on the base panel when in the expanded configuration.

In another embodiment, the receiving guide comprises an arrangement of spaced apart outer base wall projections operable to engage an outer surface of the side panels and/or the back panel, and an arrangement of spaced apart inner base wall projections operable to engage with an inner surface of the side panels and/or the back panel.

In another embodiment, the outer base wall projections are provided on the top surface of the base wall adjacent to the perimeter of the base wall, and the inner base wall projections are provided on the top surface of the base wall and are located within the interior region of the device when in the expanded configuration.

In another embodiment, the inner base wall projections on the base wall are operable to provide a stop to prevent the side panels and/or back panel from folding into the interior region of the device.

In another embodiment, the side panels and/or back panel are operable to be lifted over the outer base wall projections and slotted in between the inner base wall projections and the outer base wall projections.

In another embodiment, a hinge pin connects the side panel and/or back panel to the base wall, whereby the hinge pin is operable to move up and down within slot formed within the base wall to enable the side panel and/or back panel to be lifted over the outer base wall projections and slotted down in between the inner base wall projections and the outer base wall projections.

For example, at least one locking protrusion is provided at a side edge of one of: the back panel and the side panels for locking engagement with a locking slot provided on the other of the back panel and the side panels.

In another embodiment, one or both of the side opening and/or top opening is covered by a closure.

In another embodiment, each closure may be provided as a strap and/or a closure panel.

For example, the strap is in the form of a web. This further reinforces the structural integrity of the load by linking the side wall and the base wall together thereby acting as a stabilising harness, whilst also preventing product from accidentally falling out the device during transportation and handling.

In another embodiment, internal stabiliser means are provided on the base wall.

The base wall comprises internal stabilisers provided on the inside of the base wall to prevent the side panels from passing the point where the side would be perpendicular. The device described by the present disclosure uses the base wall of the device stacked above it as the lid. The provision of upstanding projections on the side panels and receivers formed in the base wall provide stacking stability. The interconnection of the back panel and side panels enhance the structural integrity of the device and the projections on the side panels and receivers formed in the base wall prevent a portal frame affect by ensuring constant tension throughout the device. The device is adapted to be moved from a flat pack or folded configuration unit into an expanded configuration.

The devices may be stacked to provide a system of storage and display devices.

### BRIEF DESCRIPTION OF THE DRAWINGS

The disclosure will be more clearly understood from the following description of some embodiments thereof, given by way of example only, with reference to the accompanying drawings, in which:

FIG. 1 is a perspective view of a storage and display device in an expanded configuration;

FIG. 2 is a system comprising a plurality of storage and display devices shown in FIG. 1.

FIG. 3 is the system shown in FIG. 2 mounted on transport means or castors;

FIGS. 4 to 11 are views showing a pair of storage and display devices being connected together to form a storage and display system;

FIGS. 12 to 16 are views showing the storage and display device of FIG. 1 moving from a folded to an expanded configuration;

FIGS. 17 to 20 are perspective views showing the operation of locking bars;

FIGS. 21 to 28 are views showing the interconnection of side panels and back panel of the storage and display device of FIG. 1, and

FIGS. 29 and 31 are views showing a cover for a side opening of the storage and display device of FIG. 1, and

FIG. 32 is a view of a groove provided in a base wall of the device of FIG. 1,

FIG. 33 is a perspective view of a plurality of storage and display devices stacked in a folded configuration;

FIG. 34 is a perspective view of a storage and display device in an expanded configuration according to another embodiment;

FIG. 35 is a front view of the storage and display device shown in FIG. 34;

FIG. 36 is a top view of the storage and display device shown in FIG. 34;

FIG. 37 is a detail view of the interconnection of a side and back panel side walls of the storage and display device;

FIG. 38 is a detail view of a locking arm arrangement;

FIG. 39 is a detail view of the interconnection of a side and back panel side walls and base wall of the storage and display device;

FIGS. 40 and 41 are side views of the interconnection of a side and base wall of the storage and display device;

FIGS. 42 and 43 are step drawings showing the sequence of stages in moving the device from a folded configuration to an expanded configuration, and actuation of a locking arm arrangement provided adjacent the side opening from an unlocked to a locked configuration;

FIG. 44 is a system comprising a plurality of the storage and display devices shown in FIG. 34 in the expanded stacked configuration;

FIG. 45 is a perspective view of a storage and display device in an expanded configuration according to further embodiment;

FIG. 46 is a perspective view of a storage and display device in an expanded configuration according to still further embodiment; and

FIG. 47 is a perspective view of a storage and display device in an expanded configuration according to another embodiment, and

FIG. 48 is a perspective view of a storage and display device in an expanded configuration according to FIG. 1 further showing a closure at the top opening in the form of a strapping or webbing.

### DETAILED DESCRIPTION

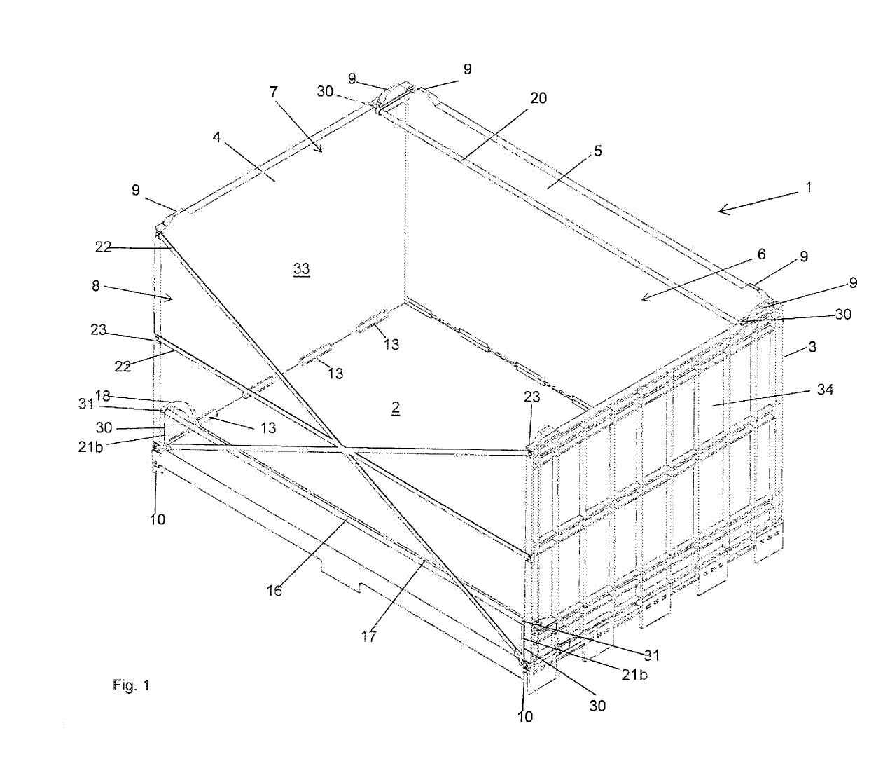

Referring to the drawings, FIG. 1 shows a storage and display device, indicated generally by the reference numeral 1. The device 1 comprises a base wall 2 and a side wall 3, wherein the side wall 3 comprises a pair of side panels 4 and a back panel 5. In operation, the base wall 2 and the side wall 3 are operable to be moved between a folded configuration and an expanded configuration, in which in the expanded configuration an interior region 6 for the storage of product is defined between the side wall 3 and the base wall 2.

When in the expanded configuration, the side panels 4 are spaced apart by the back panel 5 on the base wall 2 to form the interior region 6. The base wall 2 and side wall 3 may be pivotably connected together, such as by a hinge, or alternatively may be connected by other means, such as a sliding connection, whereby the side wall panels 4 and or back panel 5 is able to be slotted into the base wall 2 to define the interior region 6.

A top opening, indicated generally by the reference numeral 7, and a side opening, indicated by the reference numeral 8, to the interior region 6 are provided in the expanded configuration of the device 1.

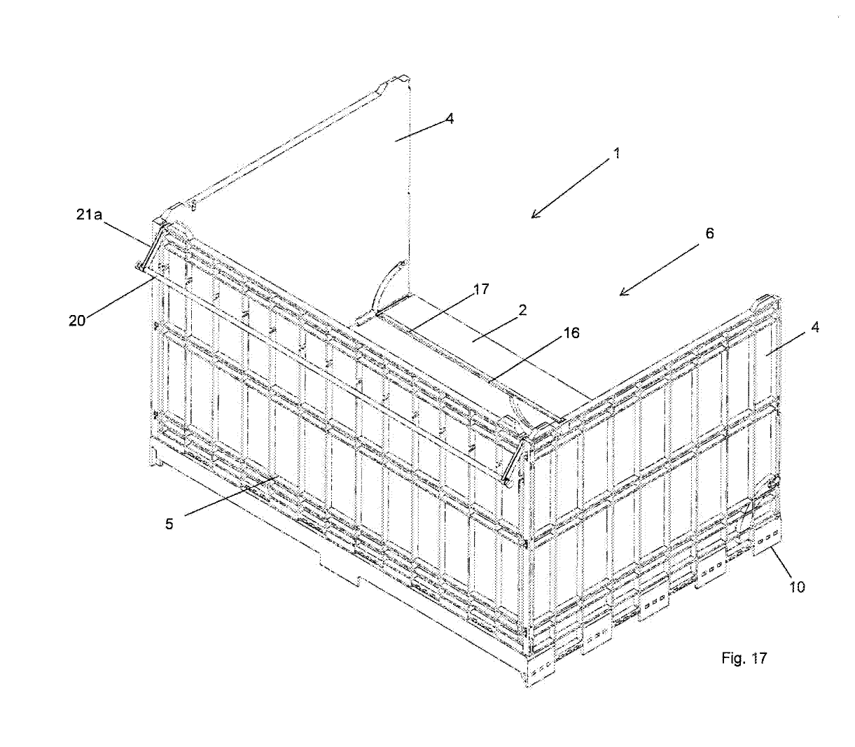

The device 1 comprises at least one locking arm arrangement comprising two pairs of connected locking arms 21: a first pair connected together at respective ends of a top opening locking bar 20 and a second pair connected together at respective ends of a locking bar 16. Each locking arm 21 has a side wall engaging locking surface 30, and together the locking arms 21 are operable to move between a locked configuration and an unlocked configuration in the expanded configuration of the device 1. As shown most clearly in FIGS. 17-20, in the locked configuration the side wall engaging locking surface 30 of each locking arm 21 abuts against a surface of the side wall 3, and in the unlocked configuration the side wall engaging locking surface 30 of the locking arm 21 is disengaged from the surface of the side wall 3 of the device 1.

Movement of each locking bar 16, 20 moves its respectively associated locking arms 21 between the locked configuration and the unlocked configuration. The locking bars 16, 20 are operable to be manually lifted by a user to pull the locking arms 21 into engagement with the side wall 3 to stabilise the device 1 in the expanded configuration. A first end 31 of each locking arm 21 is connected to a respective locking bar 16, 20 and a second end 32 of each locking arm 21 is pivotably connected to a wall of the device, such as the base wall 2 and/or the side wall 3, or between the base wall 2 and the side wall 3.

In the instance shown, a locking arm arrangement is provided substantially adjacent to the side opening 8 of the device 1, whereby in the locked configuration the side wall engaging locking surfaces 30 of the pair of locking arms 21 associated with the locking bar 16 abut against an interior surface 33 of the side wall 3. In the locked configuration of the locking arm arrangement provided at the side opening 8 of the device 1, the locking bar 16 extends fully across the side opening 8 between opposing locking arms 21 of a locking arrangement. The locking bar 16 is operable to apply a force against each of its associated locking arms 21 to push the side wall engaging locking surface 30 of each of these locking arms 21 into firm engagement against an interior surface of the side wall 3. In addition to a locking arm arrangement being provided substantially adjacent to the side opening 8 of the device 1, a locking arm arrangement is also optionally provided substantially adjacent to the top opening 7 of the device 1, whereby in the locked configuration the side wall engaging locking surfaces of the pair of locking arms 21 associated with the locking bar 20 may abut against either the interior surface 33, or the exterior surface 34 of the side wall. In the locked configuration of the locking arm arrangement provided at the top opening 7 of the device 1, the locking bar 20 extends fully across the top opening 7 between the locking arms 16 and surfaces 33, 34 of the side wall 3. The locking bar 16 is operable in the locked configuration to apply a force against each of its associated locking arms 21 to push the side wall engaging locking surface 30 of each of those locking arms 21 into firm engagement against an interior surface or an exterior surface of the side wall 3.

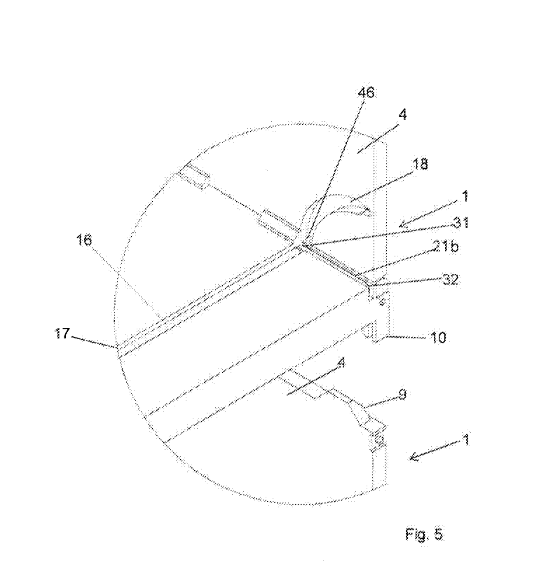

A channel 17 (shown clearly in FIG. 5) is provided in the base wall 2 for storage of the locking arm arrangement adjacent to the side opening 8, wherein the locking bar 16 is moveable from the channel 17 to move the locking arm arrangement to the locked configuration. A locking bar guide 18 is provided on the interior surface 33 of the side wall 3. The locking bar guide 18 is provided as a pair of tracks, or grooves 18, in which each groove 18 is provided at ends of the locking bar 16 and extends along the side wall 33 in the direction of movement of the locking bar 16.

Locking extensions 46 (shown in FIGS. 5 and 12-14) project perpendicularly from respective first ends 31 of the locking arms 21 and into the track 18, the locking extensions 46 operable to move within and along the track 18 when the locking bar 16 is moved between the locked and unlocked configurations.

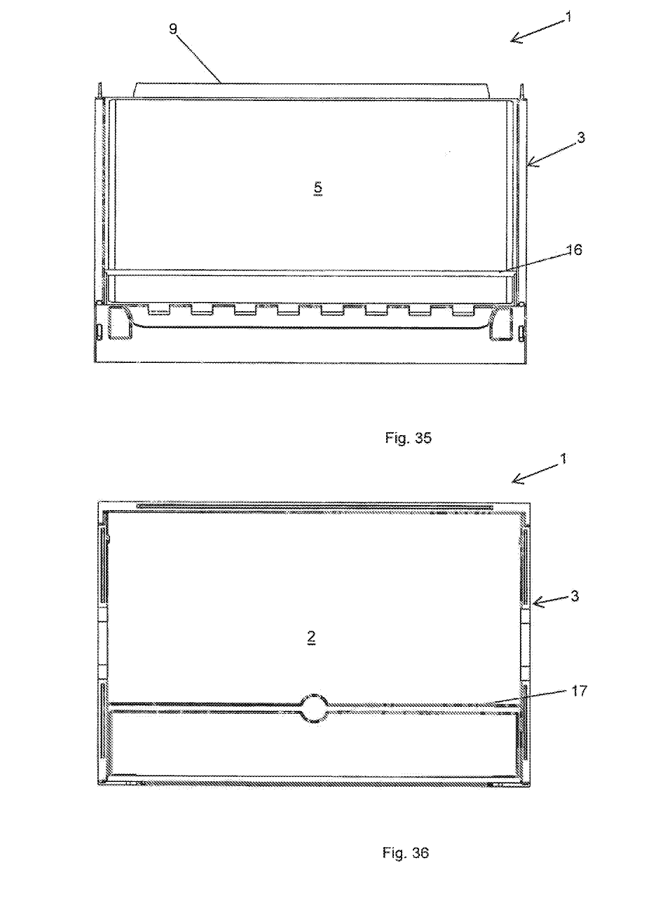

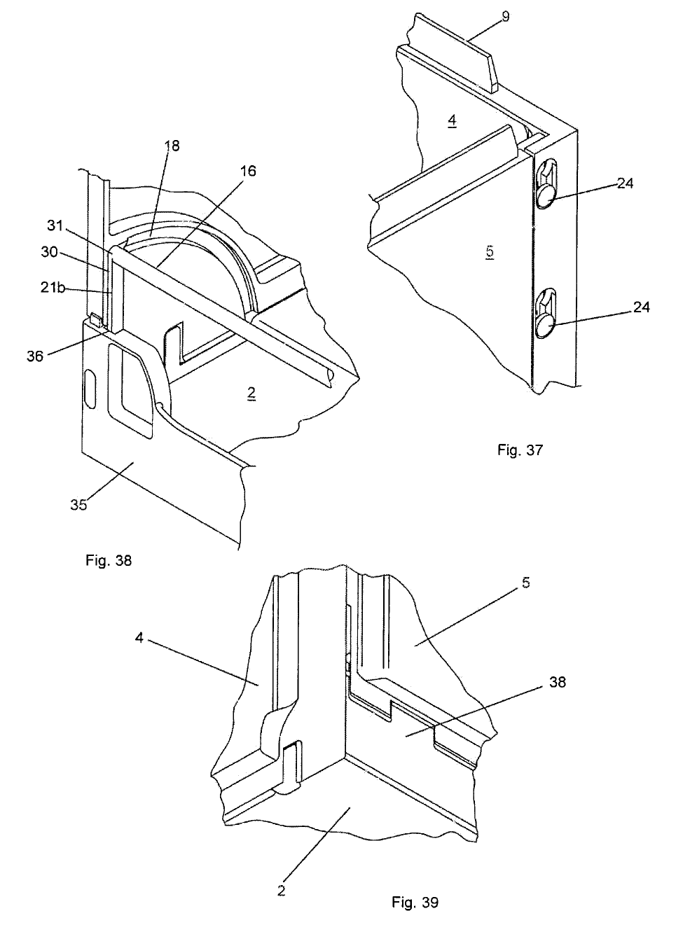

The device 1 optionally further comprises a front wall 35 (shown in FIGS. 34-38) that extends across the side opening 7, the front wall 35 comprising locking arm receivers 36 for the locking arms 16 in the locked configuration. The front wall 35 may be configured to have any height as required or as desired and its specific dimensions may depend on the physical dimensions or type of product being stored in the device. For example, the front wall 35 may have a height of only a few millimetres, only a few centimetres or extend to a position up to or even above the height of the locking bar 16 when in the locked configuration.

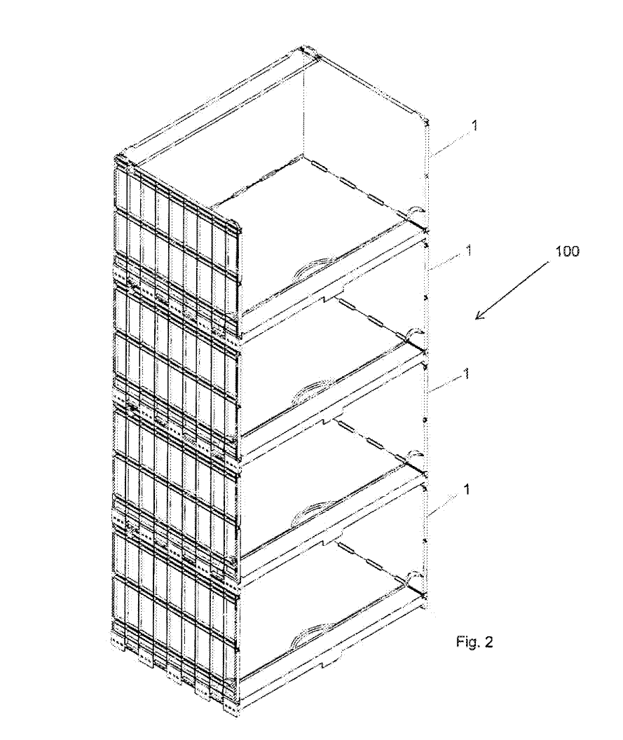

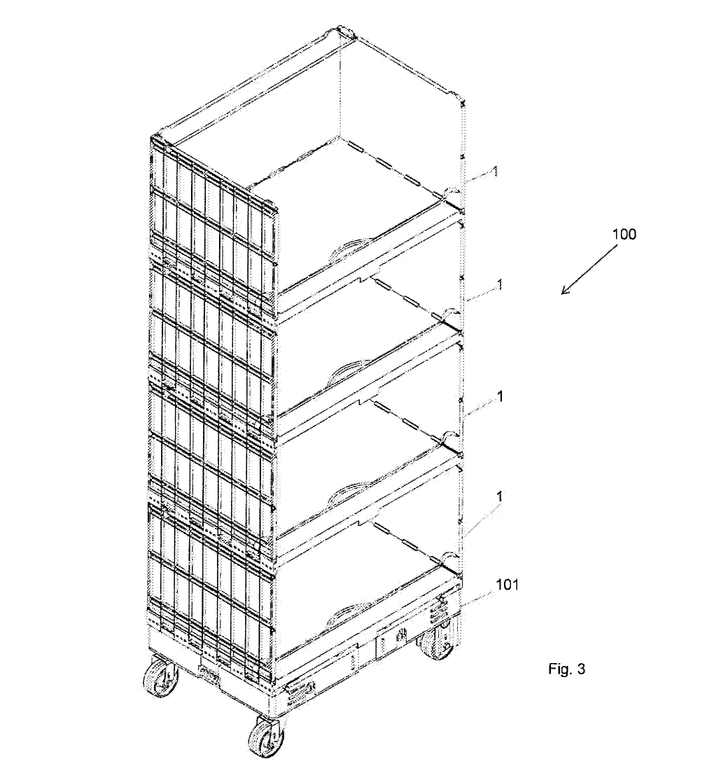

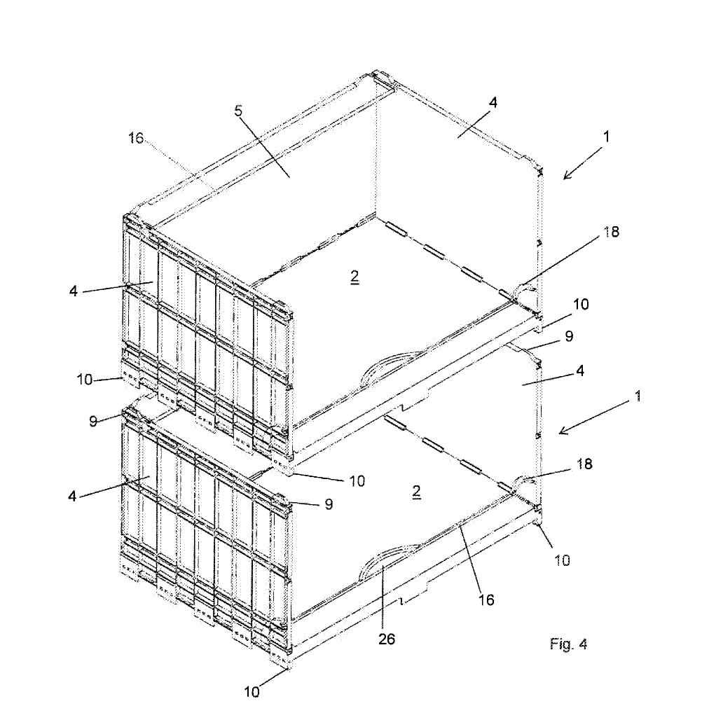

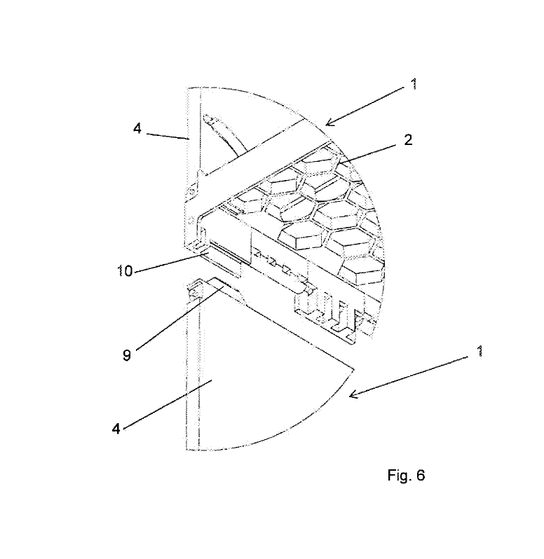

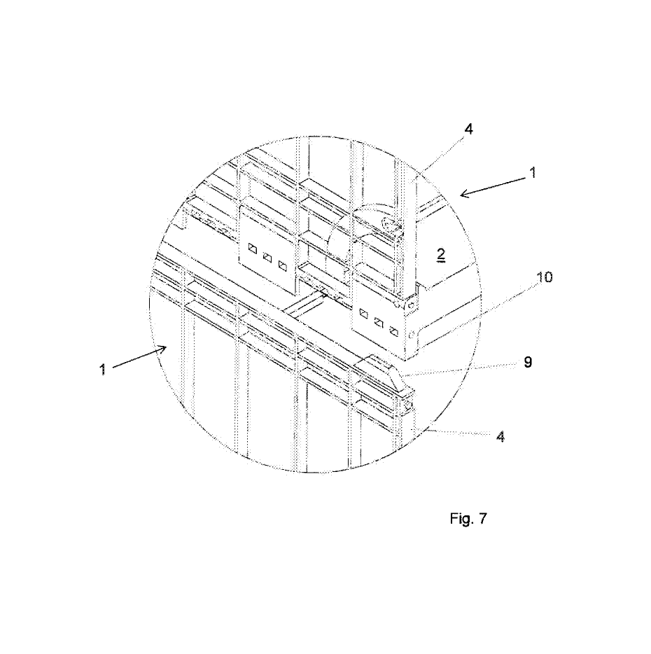

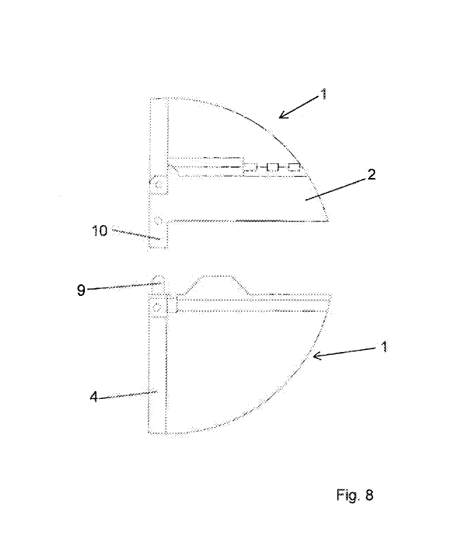

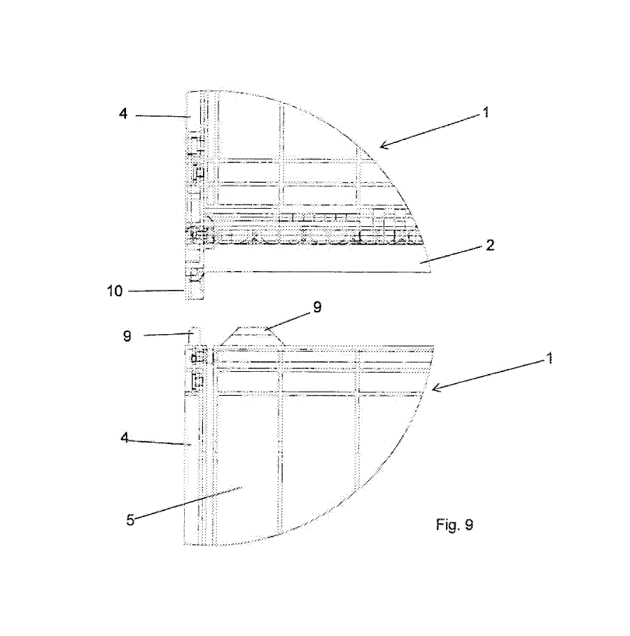

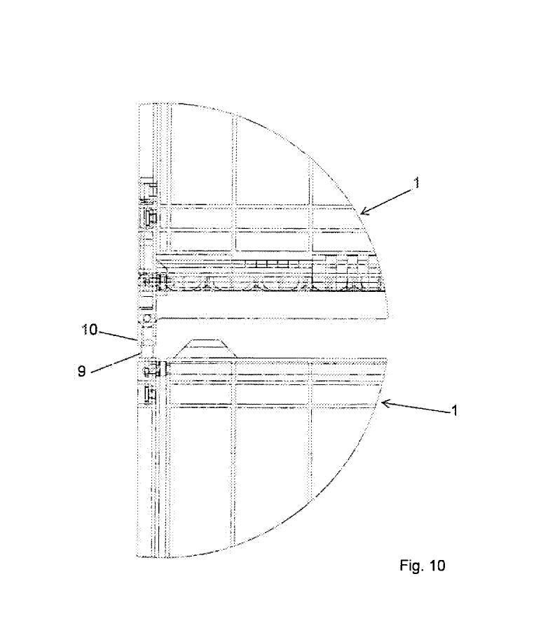

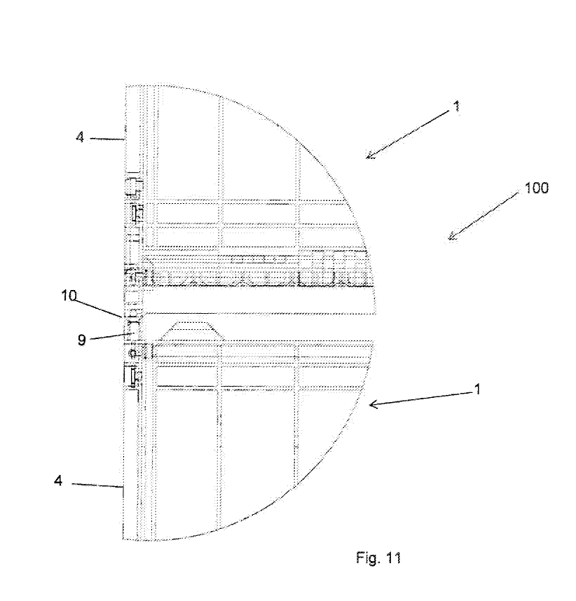

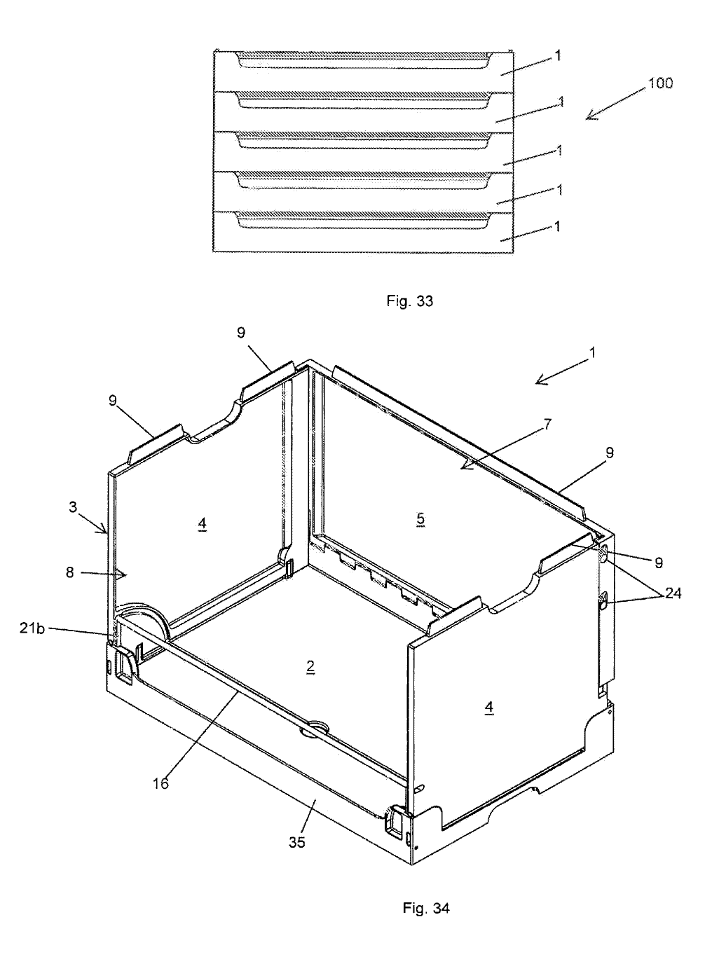

FIGS. 2 and 3 show a plurality of devices 1 arranged in a stacked configuration 100. To provide stability in such a stacked configuration, an arrangement of side wall projections 9 are provided along a top edge of the side wall 3 and which extend proud above the top opening 7, and a plurality of receivers 10 are provided on an underside of the base wall 2. Referring specifically to FIGS. 4-11, the side wall projections 9 are provided at spaced apart intervals along the top edge of the side wall 3 of the device 1 (as seen in FIG. 7), including along the side panels 4 and/or the back panel 3. As shown, one or more side wall projections 9 are provided adjacent to the top opening 7 and side opening 8 of the device 1. The receivers 10 are provided at spaced apart intervals at the perimeter of the underside of the base wall 2 and at least one receiver is provided adjacent to the side opening 8 of the device 1. The receivers 10 are shaped to receive the side wall projections 9 so that a plurality of devices 1 may be connected in the stacked arrangement 100. For example, the receivers 10 and projections 9 may provide a tongue and groove or complimentary fit such that receivers 10 are operable to slidingly and releasably engage with projections 9 of a further device 1 to provide a system 100 comprising a stacked configuration comprising at least two devices 1. Such a sliding interlocking connection will provide further stability to the stacked system 100. The system 100 may be mounted on transport means such as a trolley with castors 101 as shown in FIG. 3. The stacked configuration 100 may be arranged in either the expanded configuration of the devices 1, as seen in FIGS. 2-4, or in the folded configuration of the devices 1, as seen in FIG. 33.

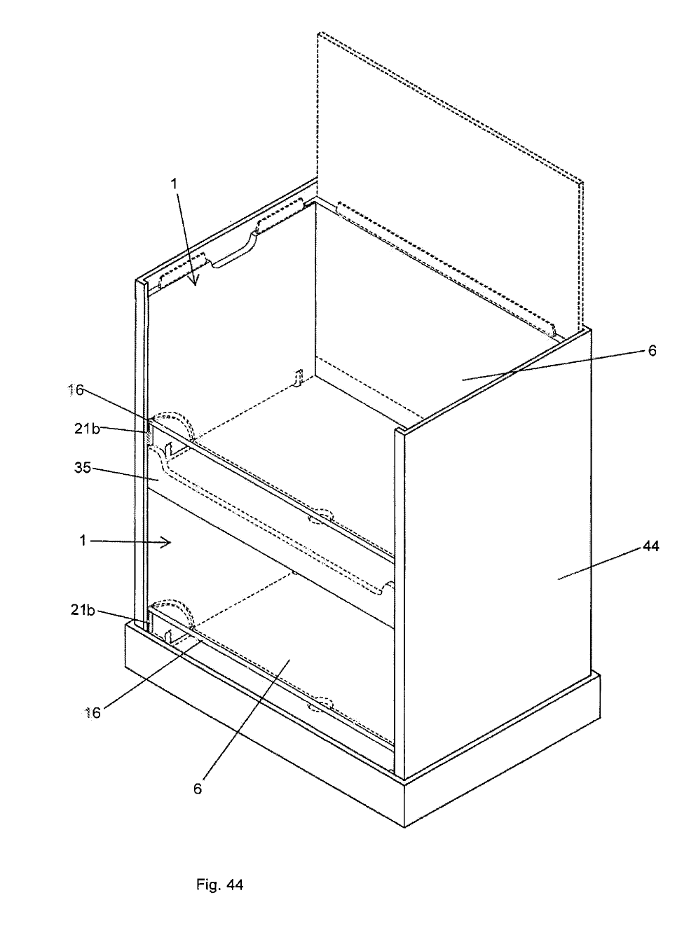

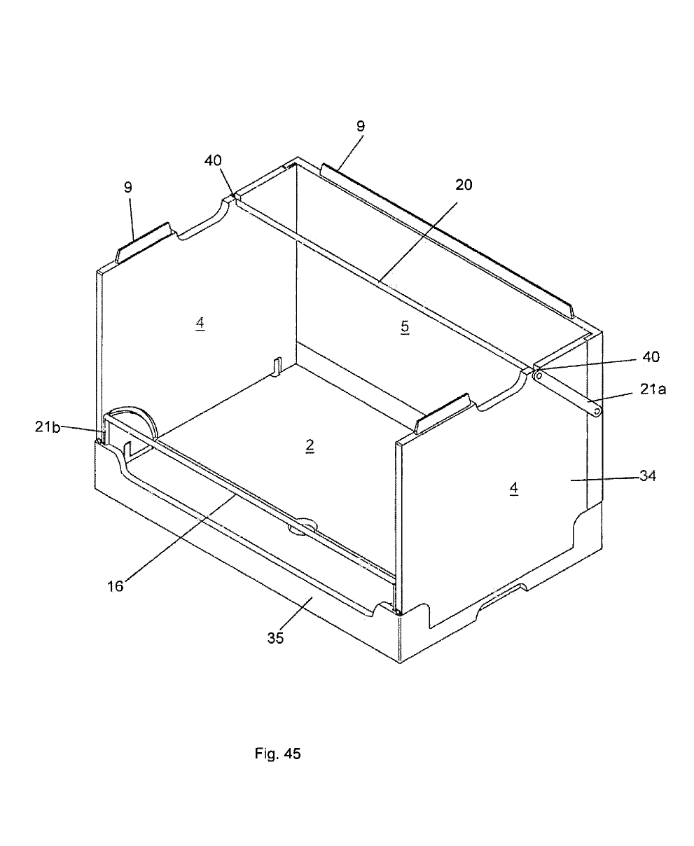

In such a stacked configuration, it will be understood that the base wall 2 of an upper device 1 in the system 100 provides a cover for the top opening 7 of a device 1 positioned beneath that device 1 in the stack. Product stored in the interior region 6 of each device 1 is accessed via the side opening 8 of each device 1, which enables product to be displayed from within the device 1. The side wall 3 may optionally be made of a transparent or a see through material or may alternatively be a printed material. A display sleeve 44 (shown in FIG. 44) may also be arranged around the stack of devices 1, such a sleeve 44 having printed thereon marketing or sales information relating to the stored displayed product.

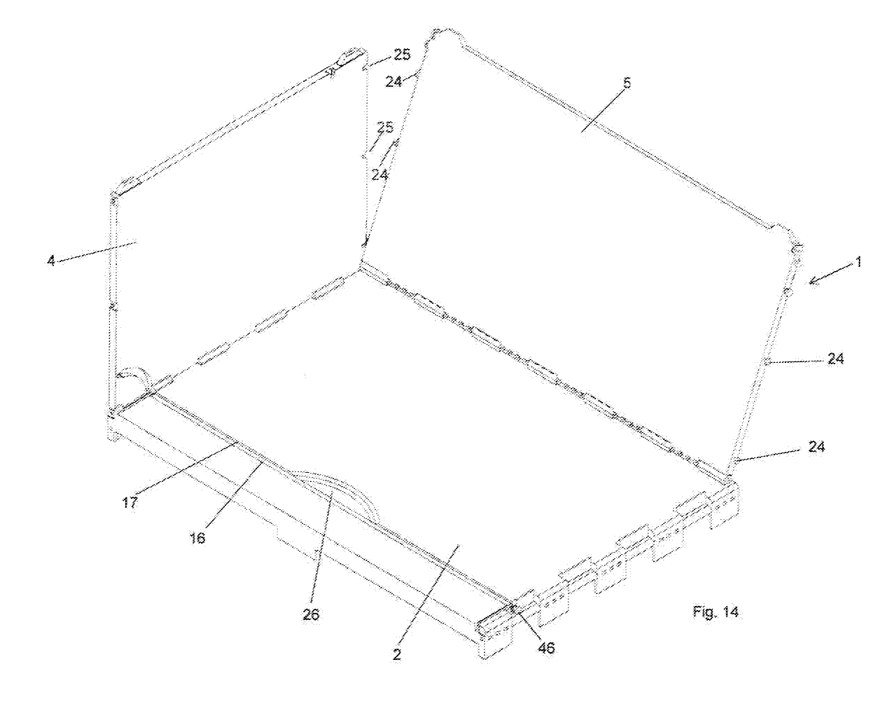

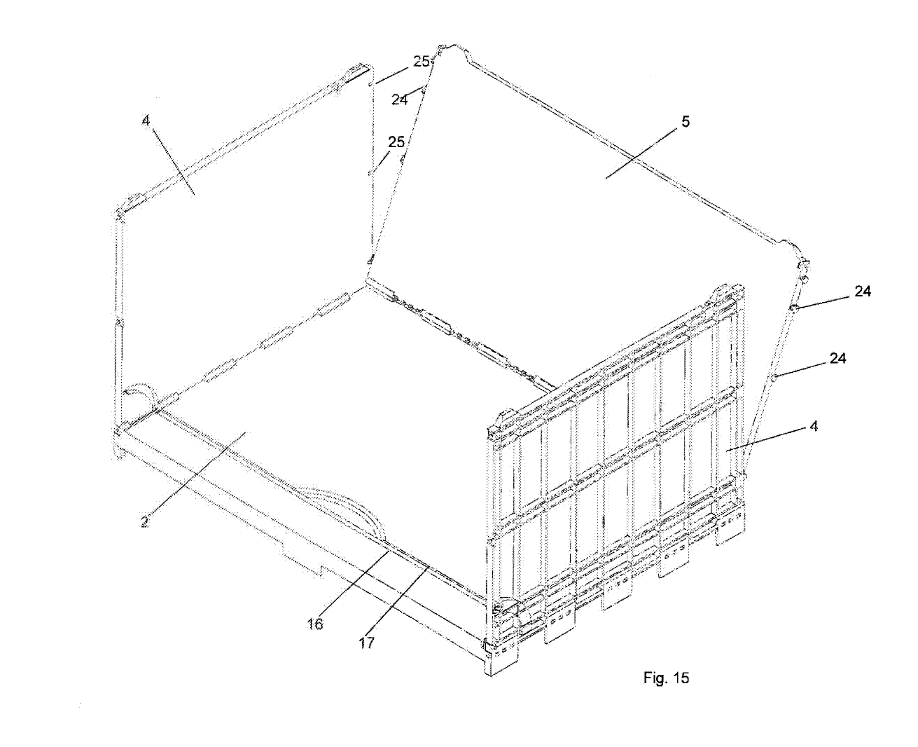

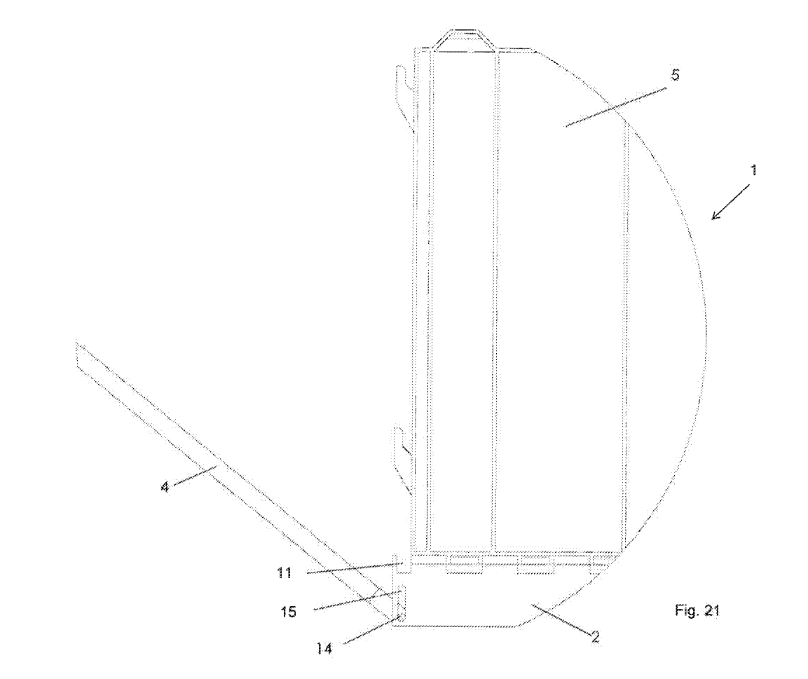

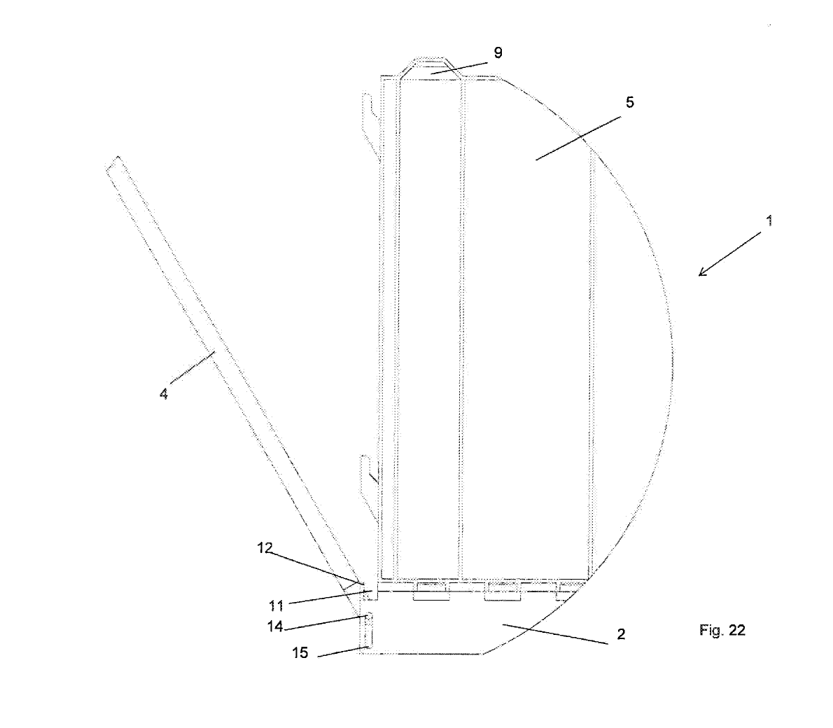

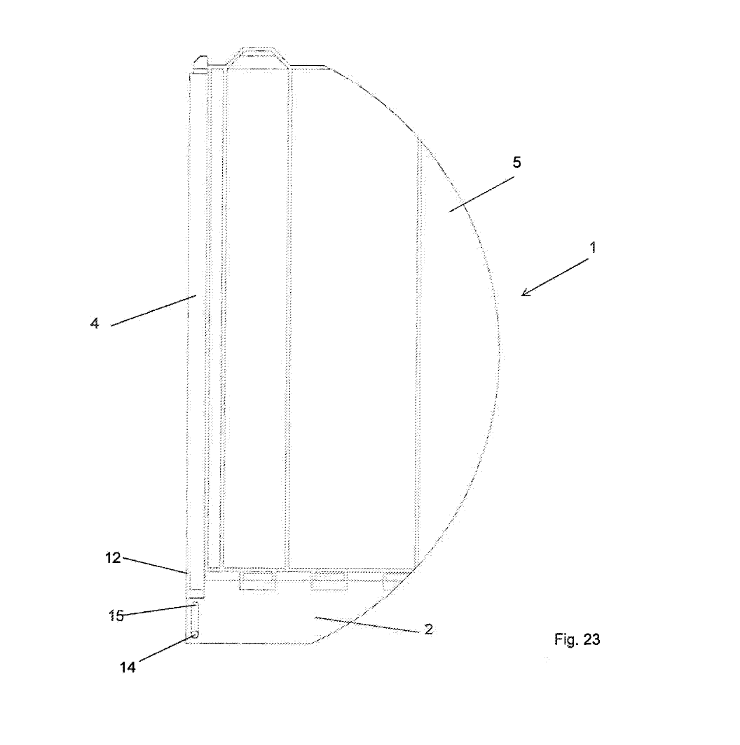

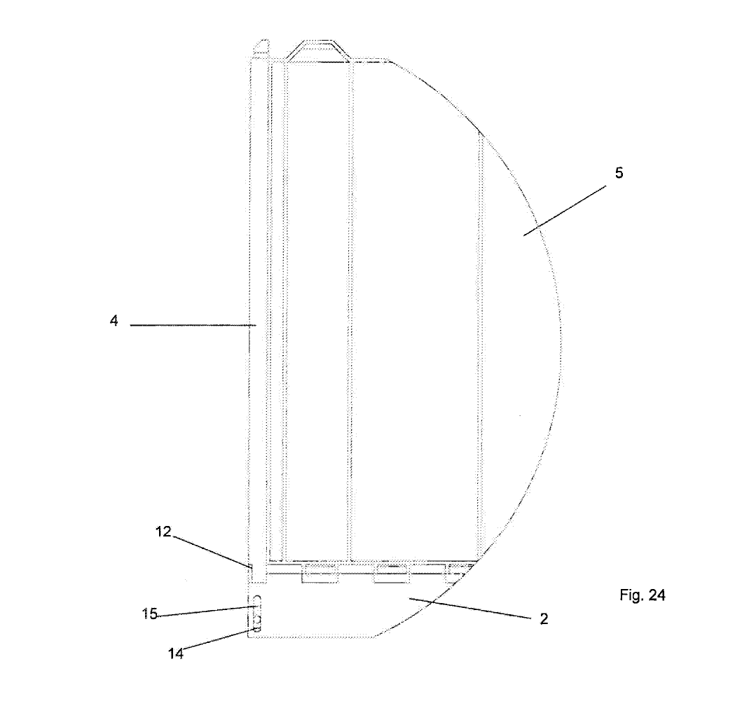

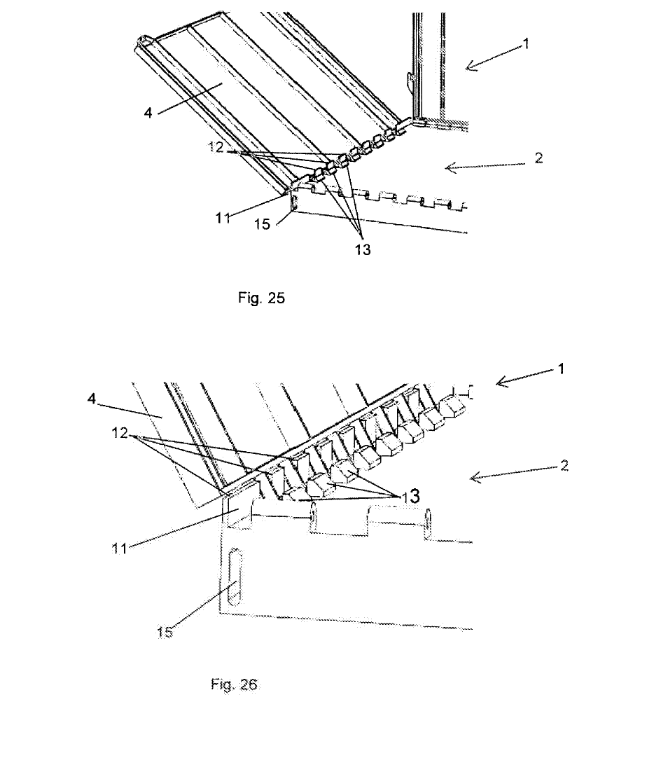

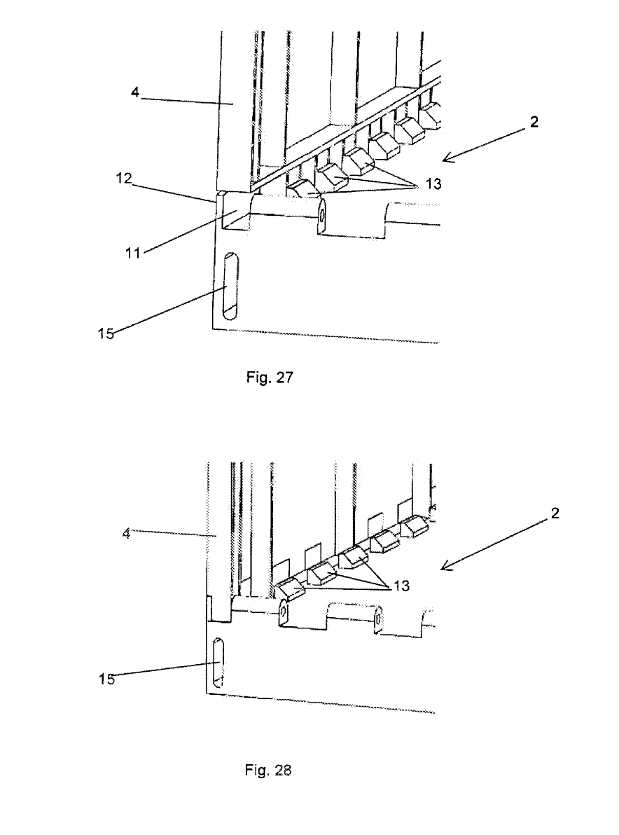

Referring to FIGS. 14 and 15, an arrangement of locking protrusions 24 is provided at a side edge of one of: the back panel 5 and the side panels 4 for locking engagement with a locking slot 25 provided on the other of the back panel 5 and the side panels 4. Although FIG. 14 shows the locking protrusions 24 on the back panel 5 and the locking slots 25 on the side panels 4, it will be understood the locking protrusions 24 may alternatively be on the side panels 4 and the locking slots 25 on the side panels 4. Referring to FIGS. 21-28, the base wall 2 comprises a rim at a perimeter thereof, the rim forming a receiving guide, indicated generally by the reference numeral 11, for positioning and locating the side panels 4 and/or the back panel 5 on the base panel 2 when in the expanded configuration.

The receiving guide 11 comprises an arrangement of spaced apart outer base wall projections 12 operable to engage an outer surface of the side panels 4 and/or the back panel 5, and an arrangement of spaced apart inner base wall projections 13 operable to engage with an inner surface of the side panels 4 and/or the back panel 5. The outer base wall projections 12 are provided on the top surface of the base wall 2 adjacent to the perimeter of the base wall 2, and the inner base wall projections 13 are provided on the top surface of the base wall 2 and are located within the interior region 6 of the device 1 when in the expanded configuration. The inner base wall projections 13 on the base wall 2 are further operable to provide a slop to prevent the side panels 4 and/or back panel 5 from folding into the interior region of the device 1. Providing one or more inner base wall projections 13 on the base wall 3 at or adjacent to the side wall opening 8 at the point of connection or joint between the side panels 4 and the base wall 2 significantly reduces or minimises the wobble effect, whilst simultaneously allowing access, and visibility of, stored products through the side opening 8.

The side panels 4 and back panel 5 are pivotably connected to the base wall 2 by connection means such as a hinge and a hinge pin arrangement, although other connection means, such as a living hinge, may also be used. A hinge pin 14 connects the side panel 4 and/or back panel 5 to the base wall 2 and is operable to move up and down within a slot formed within the base wall 2 to enable the side panel 4 and/or back panel 5 to be lifted over the outer base wall projections 12 and slotted down in between the region defined between the inner base wall projections 13 and the outer base wall projections 12. The inner wall base projections 13 may also function as internal stabiliser means to prevent the side walls 3 from folding in on the base wall 2 into the interior region.

The hinges connecting the side panels 4 and/or back panel 5 to the base wall 2 may be connected to a side edge of the base wall 2 below the interior region facing top surface of the base wall 2 to thereby create an inward resistance force against the side edge of the base wall 2 in the expanded configuration. Such positioning of the hinges further enhances stability when the side panels 4 and/or back panel 5 are substantially perpendicular to the base wall 2 in the expanded configuration and also when multiple devices 1 are interlocked and stacked.

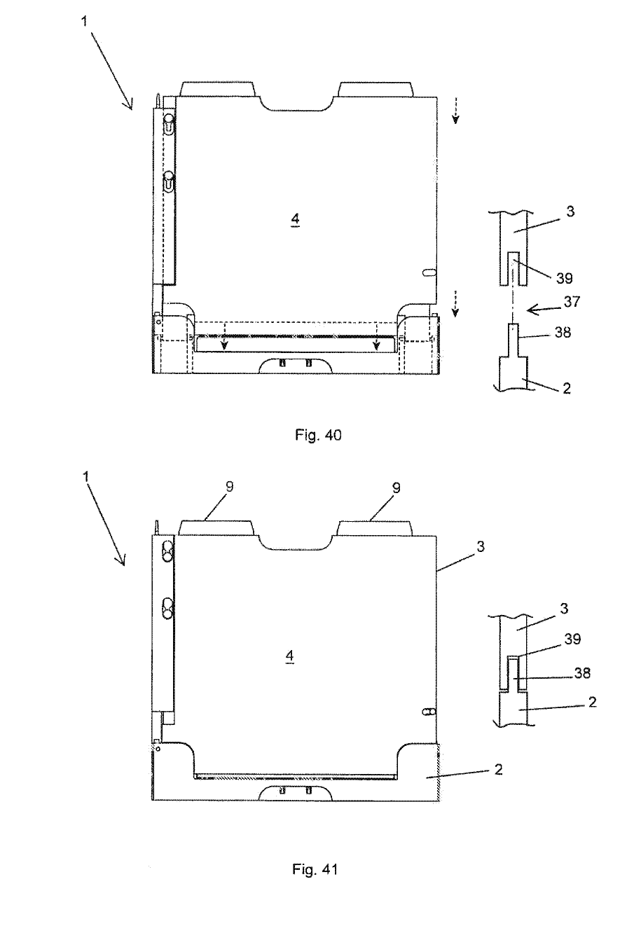

In a further embodiment as shown in FIGS. 34-41, the side wall 3 and base wall 2 are connected by a tongue and groove arrangement 37, whereby a projecting tongue 38 along one of the side wall 3 and a perimeter of the base wall 2 is operable to fit into a groove 39 that extends along the other of the side wall 3 and a perimeter of the base wall 2. Such a configuration further contributes to stability of the device 1.

The device 1 further comprises means to move the locking arms 21 in the form of at least one locking bar 16 operable to extend between the side panels 4 to secure, strengthen and stabilise the side panels 4 relative to the back panels 5 and the base wall 2.

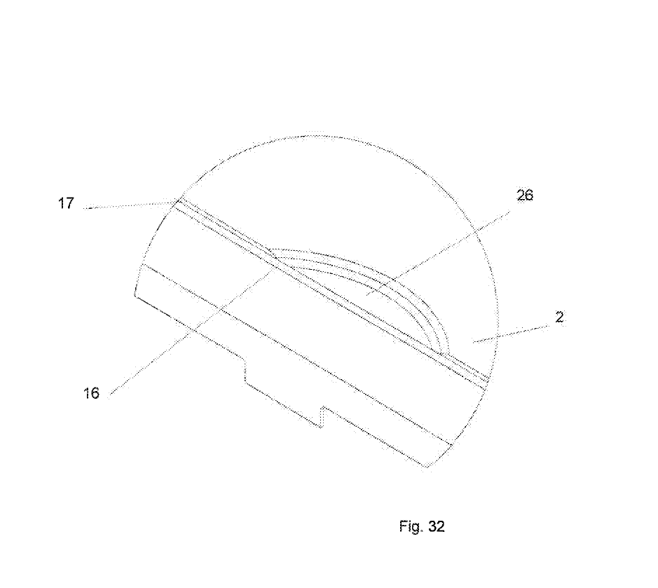

As shown, at least one locking bar is provided as a side opening locking bar 16 and is operable to extend between the side panels 4 adjacent the side opening 8 of the device 1. The base wall 2 comprises a side opening locking bar channel 17 for the storage of the side opening locking bar 16 within the base wall 2 substantially flush with the base wall. The side opening locking bar 16 is moveable from within the channel 17 such that it extends between the side panels 4 adjacent to and across the side opening 8 of the device 1. A groove 26 (shown in FIG. 32) is provided in the base wall 2 to enable the locking bar 16 to be gripped and moved from within the channel 17 in use. A guide channel comprising a track 18 is provided in the side panels 4 through which locking extensions 46 move and guide the side opening locking bar 16 into position adjacent and across the side opening 8.

A further top opening locking bar 20 extends between the side panels 4 adjacent the top opening 7 of the device 1 and provides a load bearing support for a further device 1 stacked on the device 1.

In the instance shown, each locking bar 16, 20 is connected to the device 1 by a pair of pivotably connected locking arms 21 which are secured to the device via pivots adjacent to the side opening 8 and/or the top opening 7.

In one embodiment, the pivots mounting the locking arms 21 of the side opening locking bar 16 are offset slightly back the side opening 8 by one or more inner base wall projections 13 which are mounted on the base wall 2 at or adjacent to the side opening 8 to stabilise the side panels 4 at the side opening 8.

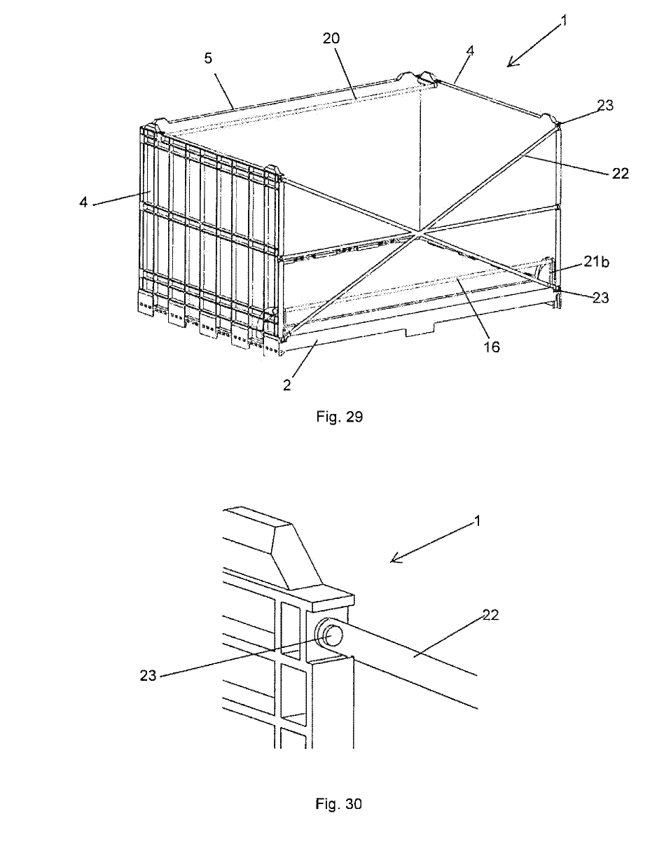

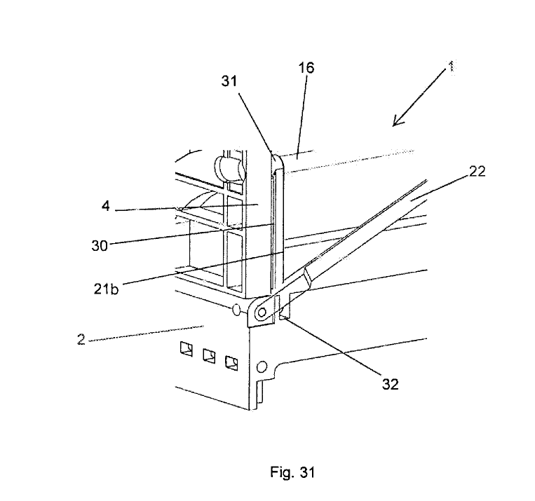

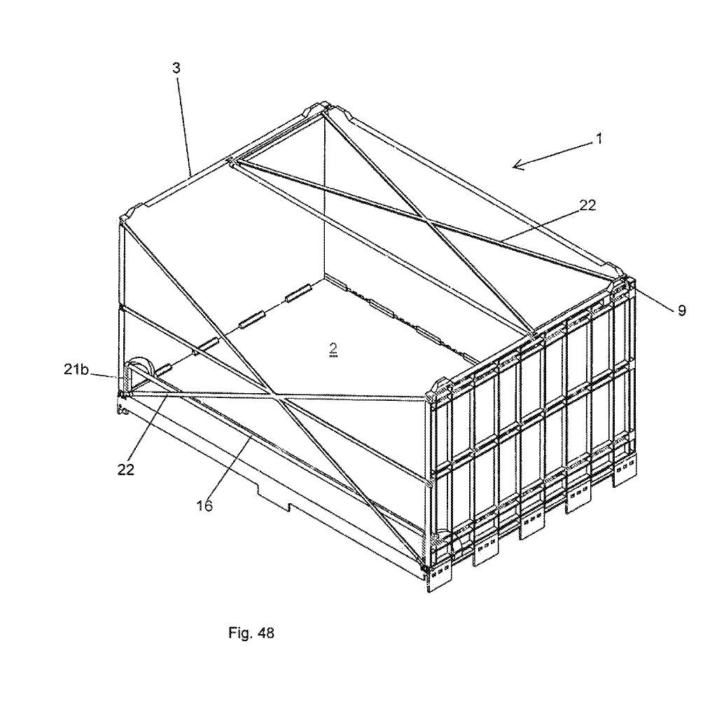

Referring to FIGS. 29-31, the side opening 8 may also be covered by a closure, such as a strap 22, or strapping 22 forming a web connected via members 23 to the side panels 4. Such strapping 22 may also be connected such that it extends between multiple devices 1 to thereby interconnect and further stabilise the connected devices 100. The top opening 7 may also be at least partially covered by a closure, such as a strap 22, or strapping 22 forming a web connected to and between the locking arms 21 provided adjacent the top opening 7 as seen in FIG. 48.

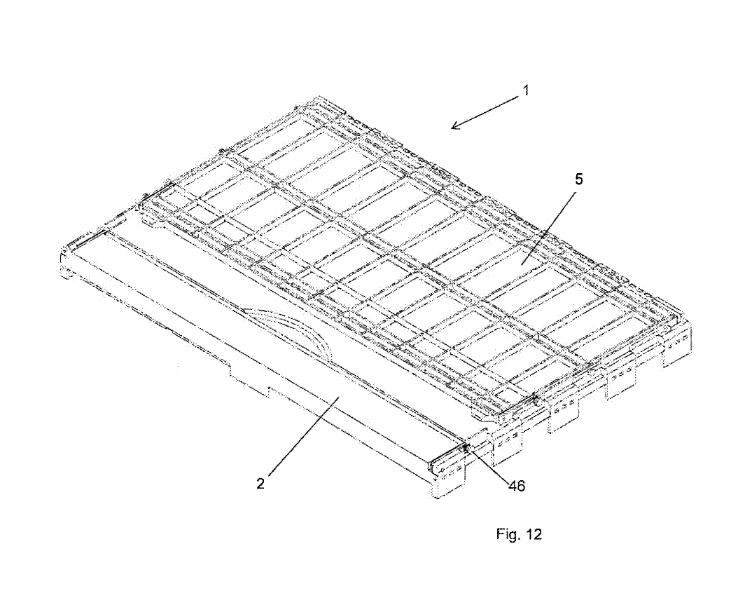

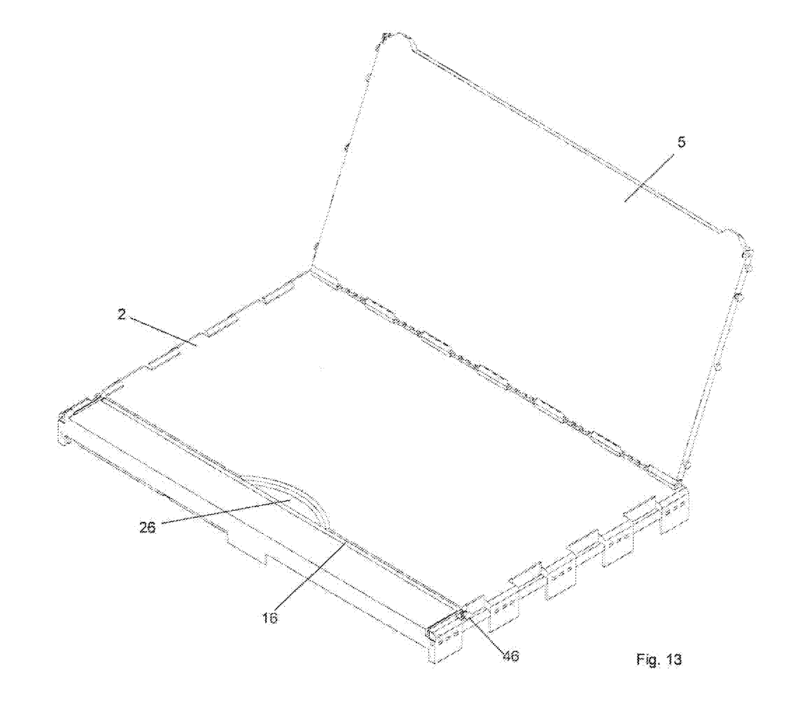

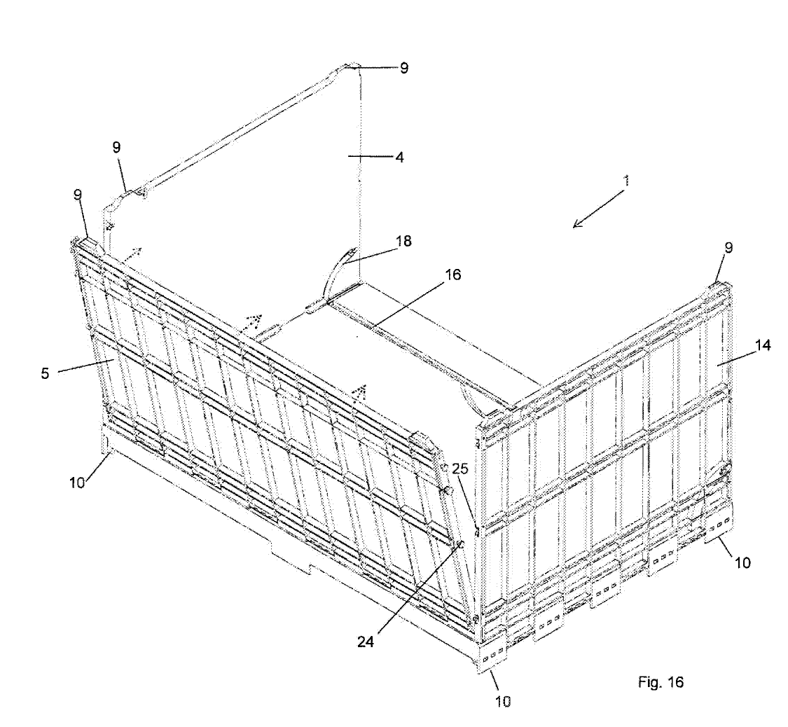

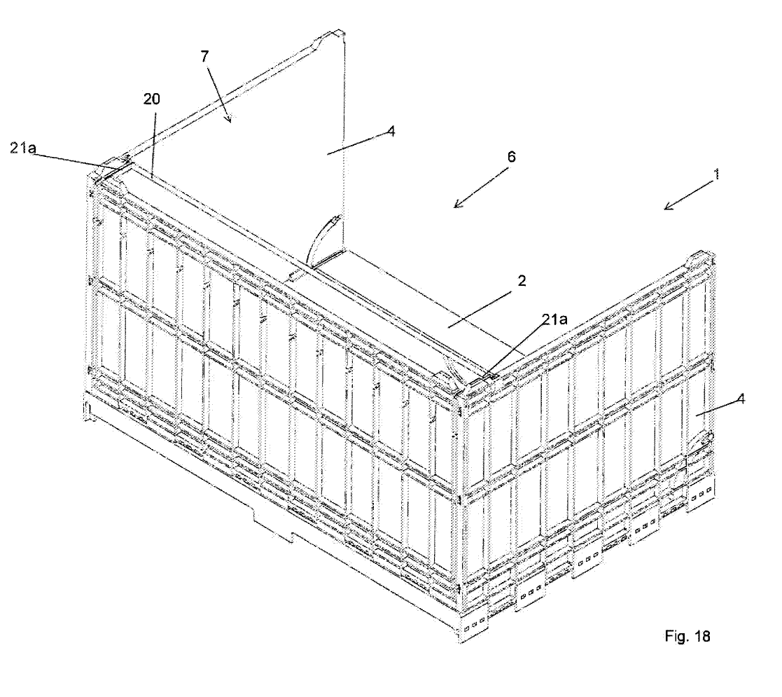

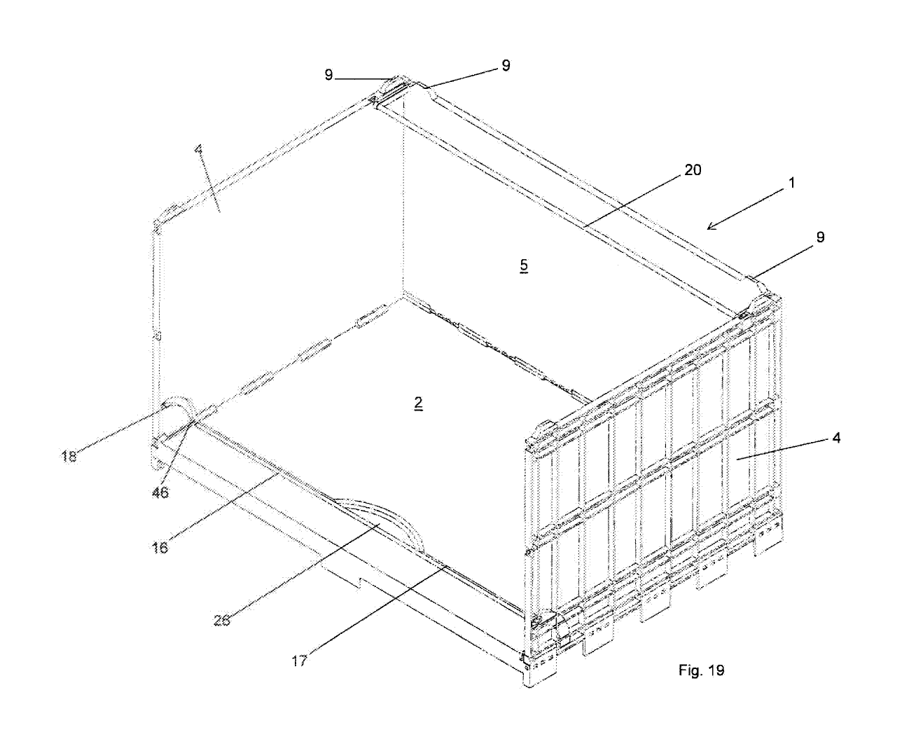

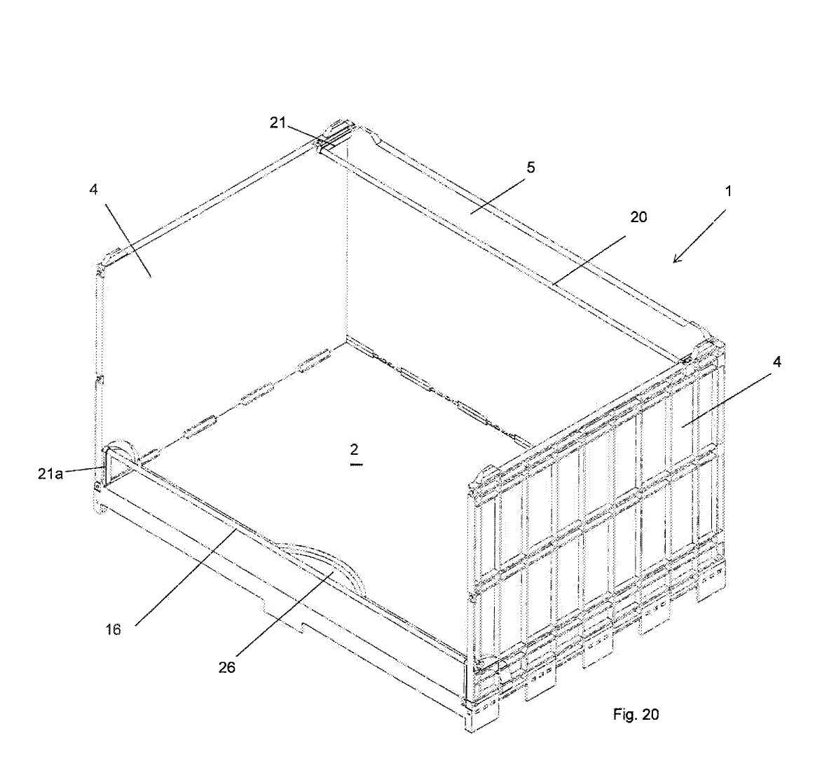

To move the device 1 from the folded configuration, as shown in FIG. 12, a user initially rotates or pivots the back panel 5 from the top surface of the base wall 2, as shown in FIG. 13. A user then rotates or pivots a side panel 4 from underneath the base wall 2 so that it movable into engagement with the back panel 5, as shown in FIG. 14. The side panel 4 is also optionally lifted over the outer base wall projections 12 and slotted down in between the region defined between the inner base wall projections 13 and the outer base wall projections 12. The other side panel 4 is similarly rotated, as shown in FIG. 15. The back panel 5 is then pushed into engagement with the side panels 4. As shown in FIGS. 16 and 17, the locking protrusions 24 provided at the side edge of the back panel 5 are slotted into the locking slots 25 provided at edges of the side panels 4 to firmly engage the panels 4, 5 together on the base wall 2. As shown in FIG. 18, the top opening locking bar 20 is pivoted over the back panel 5 so that it rests between the side panels 4 adjacent the top opening 7 of the device 1. As shown in FIGS. 19 and 20, the side opening locking bar 16 is moved from its resting channel 17 via the locking bar guide channel 18 such that it extends between the side panels 4 adjacent to and across the side opening 8 of the device 1. Once the locking bars 16, 20 are in place the side wall 3 of the device is fully locked, thereby preventing the side panels 4 and back panel 5 from falling down. The side opening 8 may then be covered by the closure that helps secure a load and support the front during transport

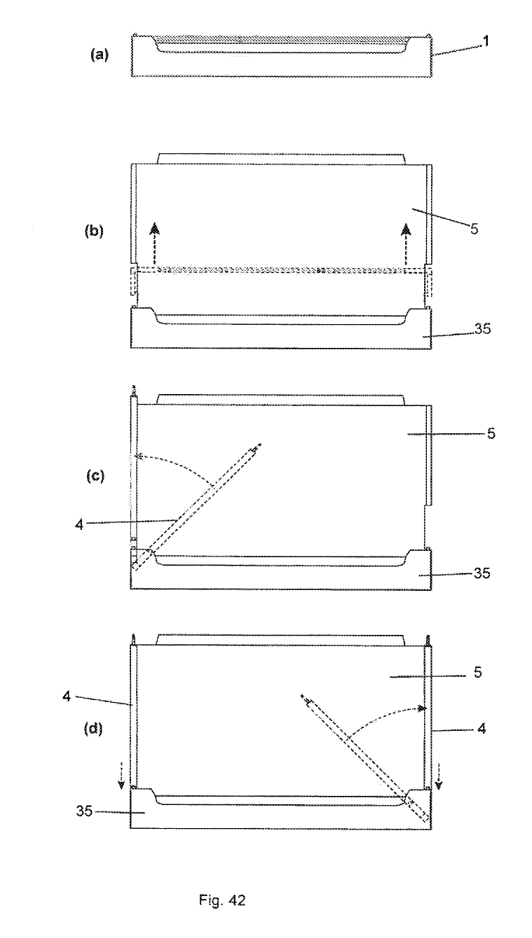

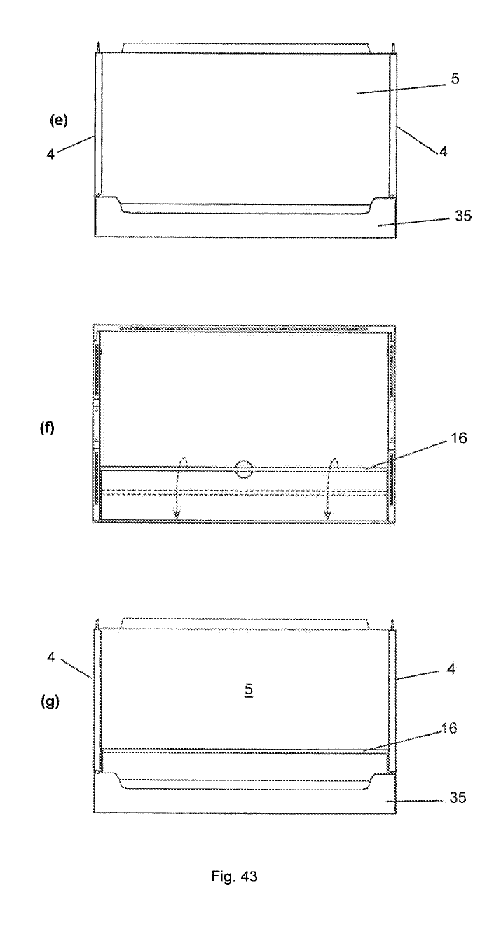

FIGS. 42 and 43 are step drawings showing the sequence of stages in moving the device of FIG. 34 from a folded configuration to an expanded configuration, and actuation of a locking arm arrangement provided adjacent the side opening from an unlocked to a locked configuration according to the invention. Initially, a user lifts the back panel 5 and then the side panels 4 of the side wall 3. Such side wall 3 may be provided on either a top or bottom surface of the base wall 2. A user then lifts the locking bar 16 from the channel 17 in the base wall 2 such that it extends across the side opening 8 of the device 1 which in turn draws the locking arms 21 into contact with the side wall panels 4 such that the side wall engaging locking surface 30 of each locking arm 21 abuts against an interior surface 33 of the side wall 3. In the locked configuration of the locking arm arrangement provided at the side opening 8 of the device 1 the locking bar 16 extends fully across the side opening 8 fully between opposing interior surfaces 33 of the side wall 3. It will be understood that the side wall 3, which comprises one or both of a side panel 4 and a back panel 5, may fold into and out of, or from underneath the base wall 2.

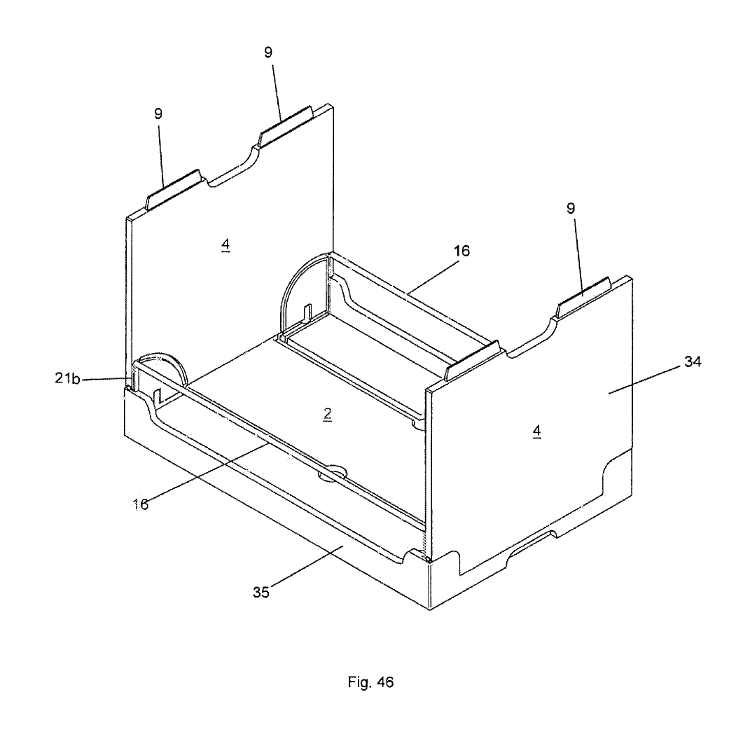

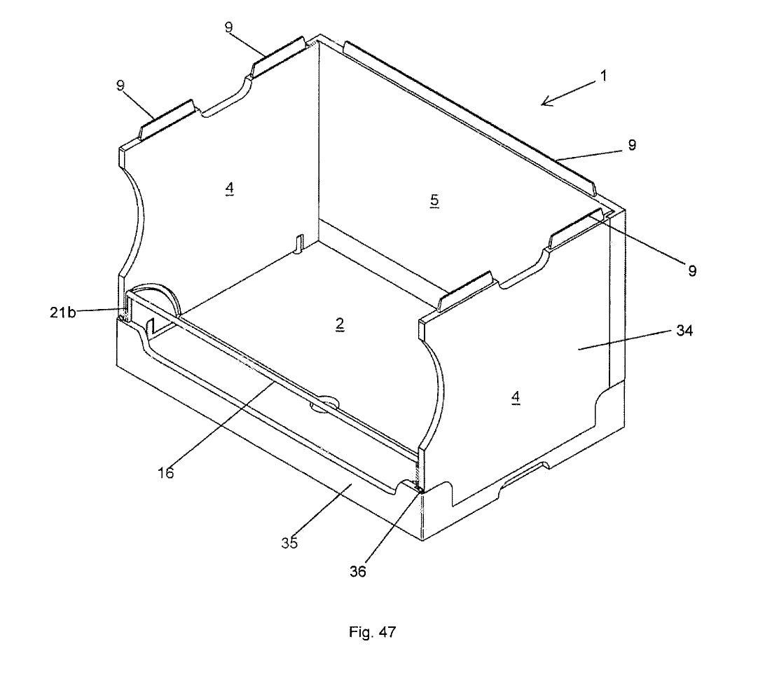

As shown in FIG. 44, an arrangement of devices 1 may be stacked and provided with a display sleeve 42 upon which advertising and marketing information may be printed. As shown in FIG. 45, the present invention also optionally comprises a further locking arm arrangement is provided substantially adjacent to the top opening 7 of the device 1, whereby in the locked configuration of such a further locking arm arrangement, a side wall engaging locking surface of each locking arm 21 abuts against either the exterior surface 34 of the side wall 3 and the locking bar 20 extends fully across the top opening 7 between the arms 16 and surfaces 33, 34 of the side wall 3. A receiving notch 40 is provided in a top edge of the side wall 3 for the top bar 20. FIG. 46 show a further embodiment of the present invention, in which the side wall 3 comprises a pair of facing side panels 4 such that side openings 8 are provided at the front and back of the device 1. FIG. 46 shows that the side wall 3 of the present invention may therefore not include a back panel 5. In such an embodiment stored product may be inserted or removed from the device 1 from both the back and the front of the device in the expanded configuration of the device. In the embodiment shown, a locking arm arrangement is provided substantially adjacent to both side openings 8 at the front and back of the device 1, FIG. 47 shows a still further embodiment corresponding to FIG. 34 in which the side panels 4 further comprise a pair of arc shaped cut out portions 41 for display purposes.

Aspects of the present invention have been described by way of example only and it should be appreciate that additions and/or modifications may be made thereto without departing from the scope thereof as defined in the appended claims.

1: A storage and display device comprising:
a base wall and a side wall, the base wall and the side wall are operable to move between a folded configuration and an expanded configuration,
in which in the expanded configuration an interior region for the storage of product is defined between the side wall and the base wall, and the side wall and the base wall are arranged to provide a top opening and a side opening to the interior region;
wherein the device comprises at least one locking arm arrangement comprising a pair of connected locking arms each having a side wall engaging locking surface at a first end and together operable to move between a locked configuration and an unlocked configuration in the expanded configuration of the device, in which in the locked configuration the side wall engaging locking surface of each locking arm abuts against a surface of the side wall, and in the unlocked configuration the side wall engaging locking surface of the locking arm is disengaged from the surface of the side wall of the device,
wherein the device comprises hinges connecting the side wall to the base wall and being connected to a side edge of the base wall below the interior region facing top surface of the base wall to thereby create an inward resistance force against the side edge of the base wall in the expanded configuration of the device.

2: A storage and display device as claimed in claim 1, in which each locking arm arrangement further comprises an elongate locking bar, and the locking arms are connected at respective ends of the locking bar, whereby movement of the locking bar moves the locking arms between the locked configuration and the unlocked configuration.

3: A storage and display device as claimed in claim 2, in which in each locking arm arrangement, a first end of each locking arm is connected to the locking bar and a second end is pivotably connected to the base wall and/or the side wall.

4: A storage and display device as claimed in claim 1, in which a locking arm arrangement is provided substantially adjacent to the side opening of the device, whereby in the locked configuration the locking bar is operable to apply a force against each locking arm to push the side wall engaging locking surface of each locking arm into firm engagement against an interior surface of the side wall.

5. A storage and display device as claimed in claim 1, in which in the locked configuration of the locking arm arrangement provided at the side opening of the device the locking bar extends fully across the side opening between the locking arms.

6: A storage and display device as claimed in claim 1, in which a locking arm arrangement is provided substantially adjacent to the top opening of the device, whereby in the locked configuration the locking bar is operable to apply a force against each locking arm to push the side wall engaging locking surface of each locking arm into firm engagement against an interior surface or an exterior surface of the side wall.

7: A storage and display device as claimed in claim 6, in which in the locked configuration of the locking arm arrangement provided at the top opening of the device the locking bar extends fully across the top opening between the locking arms.

8: A storage and display device as claimed in claim 1, in which a channel is provided in the base wall for storage of the locking arm arrangement provided adjacent to the side opening, wherein the locking bar is moveable from the channel to move the locking arm arrangement to the locked configuration.

9: A storage and display device as claimed in claim 8, in which the channel is configured to store the locking bar with the base wall substantially flush with the base wall, when the locking arm arrangement is in the unlocked configuration.

10: A storage and display device as claimed in claim 1, in which a locking bar guide is provided on the interior surface of the side wall.

11: A storage and display device as claimed in claim 10, in which the locking bar guide is provided as a track that extends along the side wall in the direction of movement of the locking bar adjacent to the side opening.

12: A storage and display device as claimed in claim 11, in which locking extensions project from respective first ends of the locking arms into the track, the locking extensions being operable to move within the track when the locking bar is moved between the locked and unlocked configurations.

13-43. (canceled)

44: A storage and display device as claimed in claim 1, in which the device further comprises a front wall that extends across the side opening, the front wall comprising locking arm receivers for the locking arms in the locked configuration.

45: A storage and display device as claimed in claim 44, in which the locking arm receivers are recesses for receiving the locking arms in an embedded fashion.

46: A storage and display device as claimed in claim 1, in which the device is re-useable.

47: A storage and display device as claimed in claim 1, in which the second end of each locking arm is pivotably connected to the base wall or the side wall or both or between the base wall and the side wall such that the pivoting connection between the second end of each locking arm and the base wall or side wall is provided below the interior region facing top surface of the base wall.

48: A storage and display device as claimed in claim 1, in which the side opening is covered by a closure, such as a strap or strapping forming a web connected via members to the side walls, which closure is configurable to extend between multiple such devices to thereby interconnect and further stabilise the connected devices.
